(19) United States
(12) Patent Application Publication
(10) Pub. No.: US 2015/0103562 A1
(43) Pub. Date: Apr. 16, 2015

(54) Switching Power Supply with a Resonant Converter and Method Controlling the Same

(71) Applicant: Acbel Polytech Inc., Taipei (TW)

(72) Inventors: Chia-An Yeh, New Taipei City (TW); Wei-Liang Lin, New Taipei City (TW)

(73) Assignee: Acbel Polytech Inc., Taipei (TW)

(21) Appl. No.: 14/054,895

(22) Filed: Oct. 16, 2013

(51) Int. Cl. H02M 3/335

(52) U.S. Cl. CPC H02M 3/33507
USPC 363/17; 363/21.02

(57) ABSTRACT

A switching power supply with a resonant converter has an AC to DC converter and a DC to DC converter. The AC to DC converter converts an inputted AC power into a DC power. The DC to DC converter has a resonant converter determining a current operating state according to waveforms of a transformer voltage and a driving signal actually measured and further controlling a switching frequency of the resonant converter to approach or to be equal to a resonant frequency for operational efficiency enhancement. Accordingly, the failure to accurately calculate a resonant frequency beforehand can be solved and the issue of accurately keeping the switching frequency consistent with the resonant frequency can be tackled.

### BACKGROUND OF THE INVENTION

1. Field of the Invention

The present invention relates to a switching power supply with a resonant converter and a method controlling the same, and more particularly to a switching power supply with a resonant converter compensating a switching frequency thereof to approach a resonant frequency thereof.

2. Description of the Related Art

With reference to FIG. 12, a conventional switching power supply with a resonant converter has an AC (Alternating Current) to DC (Direct Current) converter 70 and a DC to DC converter 80 formed by a resonant converter. The AC to DC converter 70 converts an AC power into a high-voltage DC power, such as 380 V DC power. The DC to DC converter 80 then converts the high-voltage DC power into a DC power with a desired voltage. The DC to DC converter 80 is formed by an LLC converter (two inductors and one capacitor). With reference to FIG. 13, an LLC converter 90 has a half-bridge circuit 91, a resonant circuit 92, a transformer 93, and an output circuit 94.

The half-bridge circuit 91 is connected to the primary side of the transformer 93 through the resonant circuit 92. The secondary side of the transformer 93 is connected to the output circuit 94.

The resonant circuit 92 has a resonant capacitor Cr, an excited inductor Lm and a resonant inductor Lr of the transformer 93. The resonant circuit 92 has two resonant frequencies. One of the resonant frequencies Fr1 is determined by the resonant capacitor Cr, the excited inductor Lm, and the resonant inductor Lr of the transformer 93. The other resonant frequency Fr2 is determined by the resonant capacitor Cr and the resonant inductor Lr of the transformer 93.

When a load of the foregoing switching power supply is relatively light or an input voltage of the LLC converter 90 is relatively high, a switching frequency Fs of the LLC converter 90 is greater than the resonant frequency Fr2 and a gain obtained by a ratio between an output voltage and an input voltage of the LLC converter 90 is lowered. When the load of the LLC converter 90 is relatively heavy or an input voltage of the LLC converter 90 is relatively low, the resonant converter 90 lowers the switching frequency Fs to acquire a higher gain, thereby satisfying the load demand. Under the circumstance, the switching frequency Fs is lower than the resonant frequency Fr2.

From the foregoing, the LLC converter 90 adjusts the switching frequency thereof according to how the load or the input voltage varies. Generally, when the switching frequency Fs approaches or is equal to the resonant frequency Fr2, the switching power supply has an optimal working efficiency. As mentioned, the resonant frequency of the LLC converter 90 is determined by resonant elements, such as the resonant capacitor Cr and the resonant inductor. It means that the resonant frequency is a preset value calculated according to the specifications of the resonant elements, and the switching frequency is adjusted according to the preset value. However, the reality is that specification error of the resonant elements oftentimes exists upon production of the resonant elements, and the resonant frequency generated by the resonant elements with specification error is hard to be the same resonant frequency as indicated in the specification. Hence, even though the LLC converter 90 is accurately controlled for the switching frequency thereof to approach or be equal to the resonant frequency, an optimal working efficiency fails to be effectively achieved.

### SUMMARY OF THE INVENTION

An objective of the present invention is to provide a switching power supply with a resonant converter and a method controlling the same. The switching power supply and the method determine an operating state of the switching power supply, and adjust a switching frequency according to the operating state to make the switching frequency approach an actual resonant frequency and enhance operational efficiency.

To achieve the foregoing objective, the switching power supply with a resonant converter has an AC (Alternating Current) to DC (Direct Current) converter and a DC to DC converter.

The AC to DC converter has an AC power input terminal, a DC power output terminal and a control terminal.

The DC to DC converter has a resonant converter, a resonant controller, and a phase detector.

The phase detector is connected to the resonant converter and the resonant controller to respectively acquire a transformer voltage and a driving signal and generate a conversion voltage signal based on the transformer voltage and the driving signal.

The resonant controller generates a feedback voltage control signal according to the conversion voltage signal and sends the feedback voltage control signal to the control terminal of the AC to DC converter to adjust a DC voltage outputted from the AC to DC converter and further control a switching frequency of the resonant converter of the DC to DC converter.

The foregoing switching power supply respectively acquires waveforms of a transformer voltage and a driving signal from the resonant converter and the resonant controller with the phase detector, and calculates with the waveforms to generate a conversion voltage signal in response to a current operating state. When the conversion voltage signal is nonzero, it indicates that the switching frequency is greater than or less than the resonant frequency. The resonant controller then generates a feedback voltage control signal according to calculation of the conversion voltage signal and the Dc power voltage outputted from the AC to DC converter, and sends the feedback voltage control signal to the AC to DC converter to adjust an output voltage of the AC to DC converter, that is, an input voltage to the resonant converter. The switching frequency varies with the input voltage of the resonant converter so as to approach or to be equal to the resonant frequency.

To achieve the foregoing objective, the method controlling a switching power supply having a resonant converter has steps of:

acquiring a transformer voltage and a driving signal from a resonant converter to generate a present conversion voltage signal;

determining if the present conversion voltage signal is zero;

determining if a difference value between the present conversion voltage signal and a previous conversion voltage signal is greater than zero when the present conversion voltage signal is nonzero, wherein the previous conversion voltage signal is generated by a transformer voltage and a driving signal previously obtained; and

determining if a switching frequency of the resonant converter is reduced when the difference value is not greater than zero, decreasing the switching frequency when the switching frequency is reduced, and increasing the switching frequency when the switching frequency is not reduced.

The foregoing method first decreases or increases the switching frequency of the resonant converter, and determines a current operating state of the switching power supply according to the actually measured waveforms of the transformer voltage and the driving signal. When the present conversion voltage signal generated by the waveforms of the transformer voltage and the driving signal is nonzero, it indicates that the switching frequency of the switching power supply and the resonant frequency are inconsistent. The method further determines if the conversion voltage signal is less than a previously obtained conversion voltage signal, and if positive, indicating that the compensation direction is correct, the method further decreases or increases the switching frequency. The foregoing steps are performed continuously until the conversion voltage signal is zero. In other words, the switching frequency and the resonant frequency are consistent.

Other objectives, advantages and novel features of the invention will become more apparent from the following detailed description when taken in conjunction with the accompanying drawings.

### BRIEF DESCRIPTION OF THE DRAWINGS

FIG. 1 is a circuit diagram of a first embodiment of a switching power supply in accordance with the present invention;

FIG. 2 is a circuit diagram of a second embodiment of a switching power supply in accordance with the present invention;

FIG. 3 is a circuit diagram of a third embodiment of a switching power supply in accordance with the present invention;

FIG. 4 is a waveform diagram of a resonant circuit of the switching power supply in each of FIGS. 1 to 3 when the resonant circuit is operated at a switching frequency less than a resonant frequency;

FIG. 5 is a waveform diagram of a resonant circuit of the switching power supply in each of FIGS. 1 to 3 when the resonant circuit is operated at a switching frequency greater than a resonant frequency;

FIG. 6 is a circuit diagram of a phase detector in a DC to DC converter of the switching power supply in each of FIGS. 1 to 3;

FIG. 7 is a waveform diagram associated with transformer voltage and driving signal when the phase detector in FIG. 6 is operated at a light load;

FIG. 8 is a waveform diagram associated with transformer voltage and driving signal when the phase detector in FIG. 6 is operated at a heavy load;

FIG. 9 is a flow diagram of a first embodiment of a method compensating a switching frequency of the switching power supply in each of FIGS. 1 to 3;

FIG. 10 is a flow diagram of a second embodiment of a method compensating a switching frequency of the switching power supply in each of FIGS. 1 to 3;

FIG. 11 is a circuit diagram of a control module built in an AC to DC converter in the switching power supply in each of FIGS. 1 to 3;

FIG. 12 is a functional block diagram of a conventional, switching power supply; and

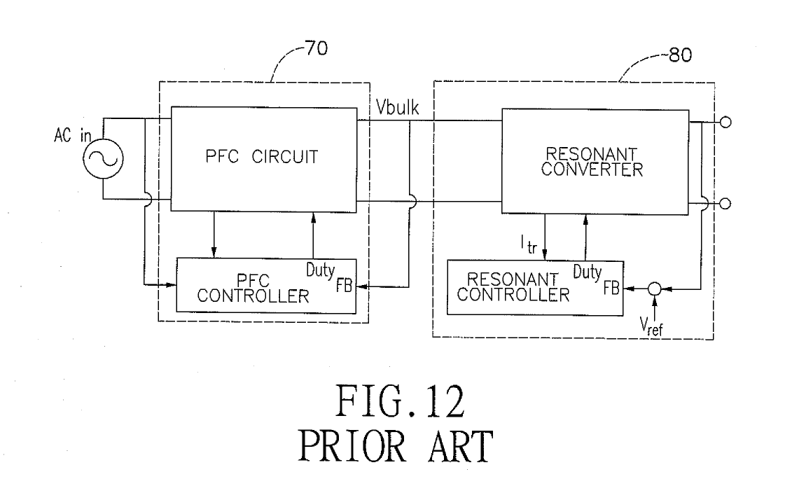

FIG. 13 is a circuit diagram of an LLC circuit in the conventional switching power supply in FIG. 12.

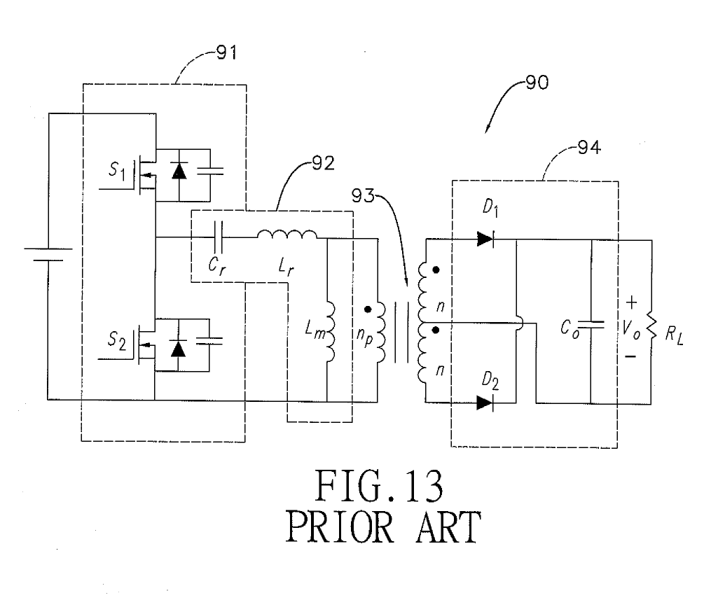

### DETAILED DESCRIPTION OF THE INVENTION

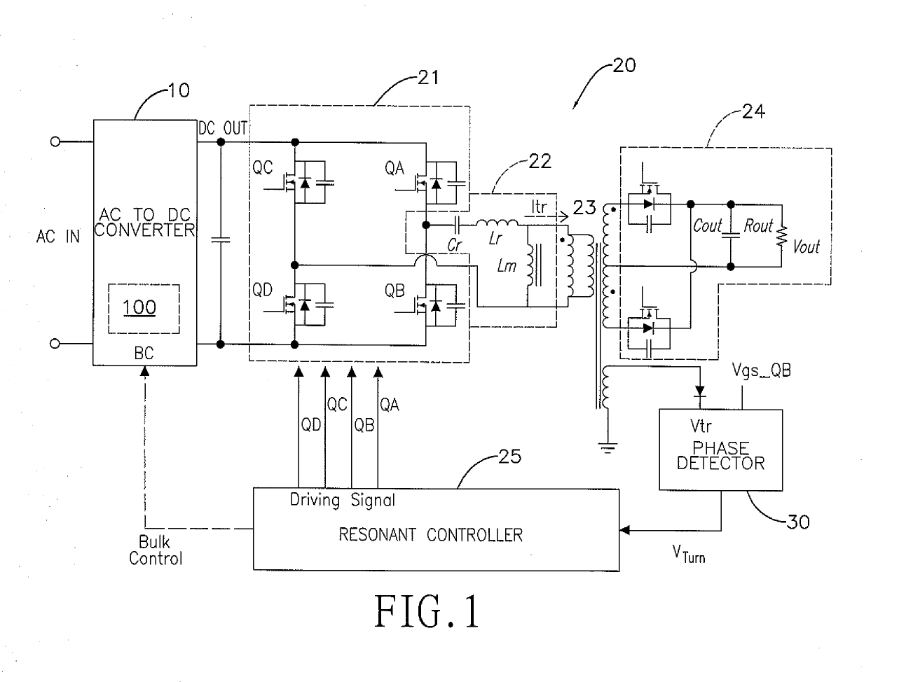

With reference to FIG. 1, a first embodiment of a switching power supply in accordance with the present invention has an AC to DC converter 10 and a DC to DC converter 20.

The AC to DC converter 10 has an AC power input terminal AC IN, a DC power output terminal DC OUT and a control terminal BC, and serves to convert a mains power inputted from the AC power input terminal AC IN into a relatively high DC voltage Vbulk and output the DC voltage Vbulk through the DC power output terminal DC OUT. The control terminal BC affects the DC voltage Vbulk outputted from the DC power output terminal DC OUT.

In the present embodiment, the DC to DC converter 20 has a resonant converter, a resonant controller 25 and a phase detector 30. The resonant converter is formed by an LLC converter, and has a full-bridge circuit 21, a resonant circuit 22, a transformer 23 and an output circuit 24.

The full-bridge circuit 21 has multiple paired electronic switches QA˜QD being alternately turned on. Each electronic switch QA˜QD is connected to the resonant controller 25, and is turned on by a driving signal provided by the resonant controller 25. The resonant circuit 22 is formed by a resonant capacitor Cr, an excited inductor Lm and a resonant inductor Lr of the transformer 23, and is connected between the DC power output terminal of the AC to DC converter 10 and the primary side of the transformer 23. The secondary side of the transformer 23 is connected to the output circuit 24.

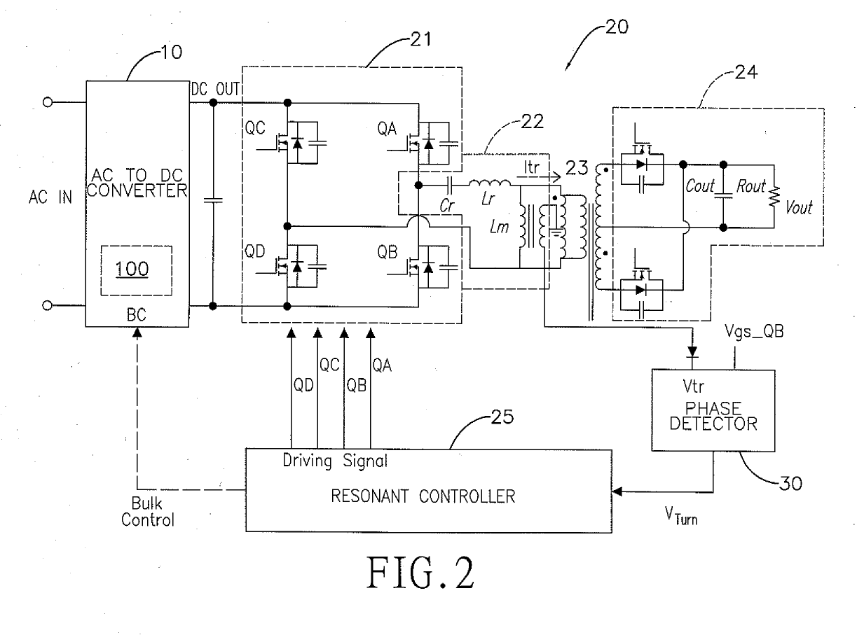

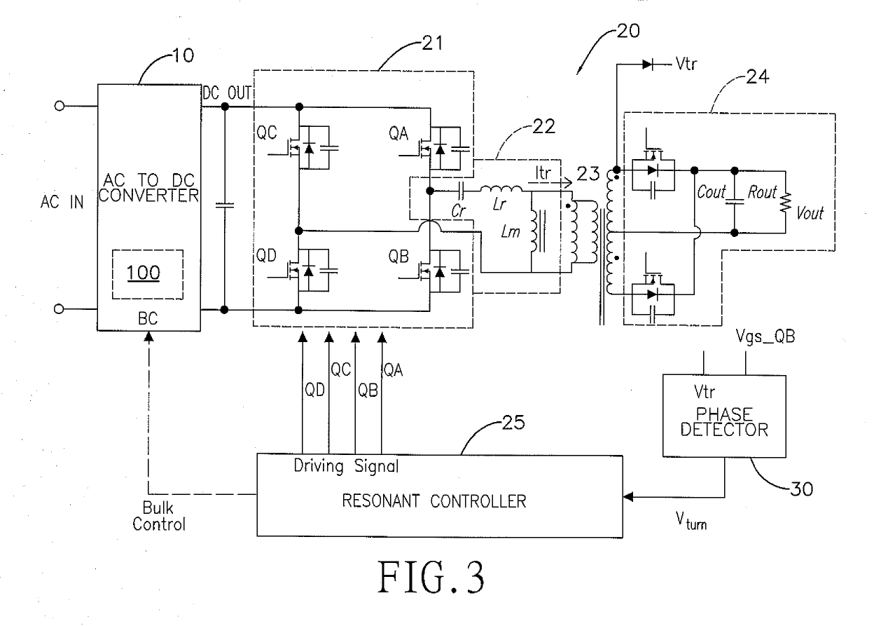

In the present embodiment, the transformer 23 has at least one transformer voltage-measuring point, such as at a coupling winding at the secondary side of the transformer 23 as shown in FIG. 1, at a coupling winding at the primary side of the transformer 23 as shown in FIG. 2, and at the secondary side of the transformer 23 as shown in FIG. 3, to provide a transformer voltage Vtr to the phase detector 30 for the phase detector 30 so as to determine a current operating state according to the transformer voltage Vtr and the driving signal (a gate-source voltage of the electronic switch QB (Vgs_QB) in the present embodiment) provided by the resonant controller 25, and to further generate a conversion voltage signal Vturn based on the transformer voltage Vtr and the driving signal. In the present embodiment, the transformer voltage is measured at the coupling winding at the secondary side of the transformer 23.

The conversion voltage signal Vturn is used to determine a current operating state. Specifically, the conversion voltage signal Vturn determines that the switching frequency Fs of the resonant converter 22 is identical to the resonant frequency Fr. The concept of determination is described as follows.

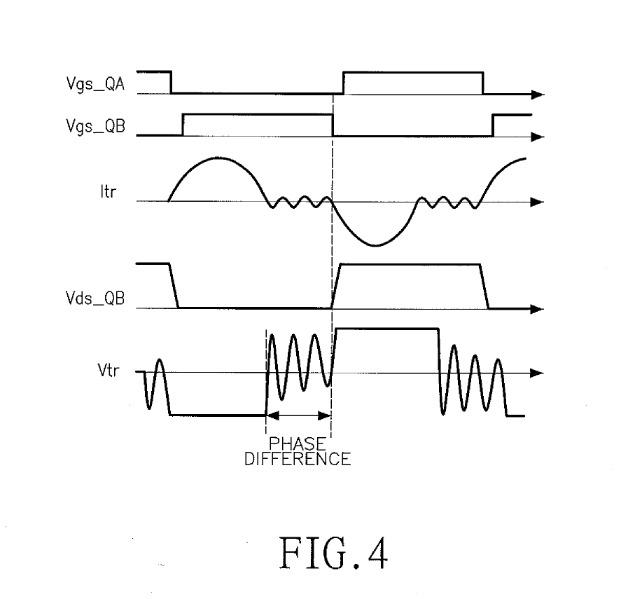

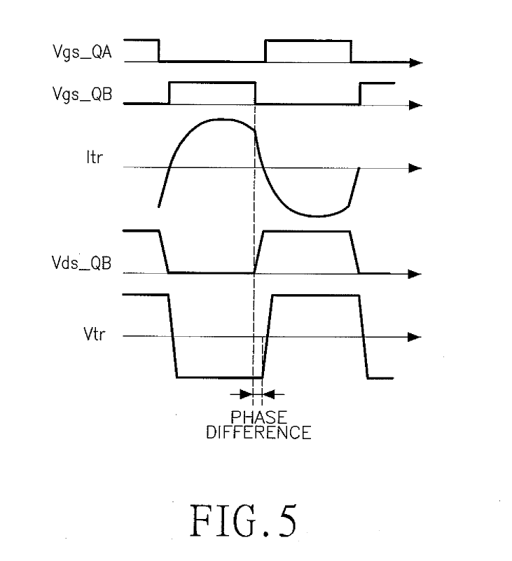

According to actual test results, when the switching frequency Fs and the resonant frequency of the LLC circuit are not the same, waveforms of the electronic switches of the full-bridge circuit 21 and the transformer 23 are illustrated in FIG. 4. It can be seen that the switching frequency Fs is less than the resonant frequency Fr2 from the observation of the waveform of the transformer voltage Vtr. Under such operating state, the switching frequency of the electronic switches QA˜QD needs to be raised. With reference to FIG. 5, an operating state when the switching frequency Fs is greater than the resonant frequency Fr2 is shown. Under such operating state, the switching frequency of the electronic switches QA˜QD needs to be lowered.

With further reference to the waveforms shown in FIGS. 4 and 5, no matter if the switching frequency Fs is greater or less than the resonant frequency Fr2, a phase difference between the waveform of the transformer voltage Vtr and that of the driving signal appears as long as the resonant frequency Fr2 and the switching frequency Fs are not equal. The present invention employs the phase detector 30 to measure the waveforms of the transformer voltage Vtr and the driving signal so as to determine whether there is inconsistency between the resonant frequency Fr2 and the switching frequency Fs for the resonant controller 25 to compensate the switching frequency Fs.

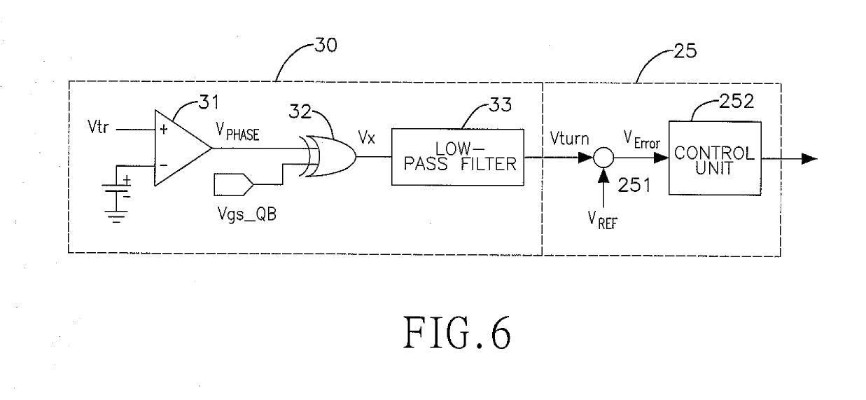

With reference to FIG. 6, the phase detector 30 has a comparator 31, a logic gate 32 and a low-pass filter 33. An input terminal of the comparator 31 is connected to any one of the at least one voltage-measuring point on the transformer 23 to acquire the waveform of the transformer voltage Vtr. A reference terminal of the comparator 31 is connected to a DC power source to serve as a DC reference voltage level. An output terminal of the comparator 31 is connected to an input terminal of the logic gate 32.

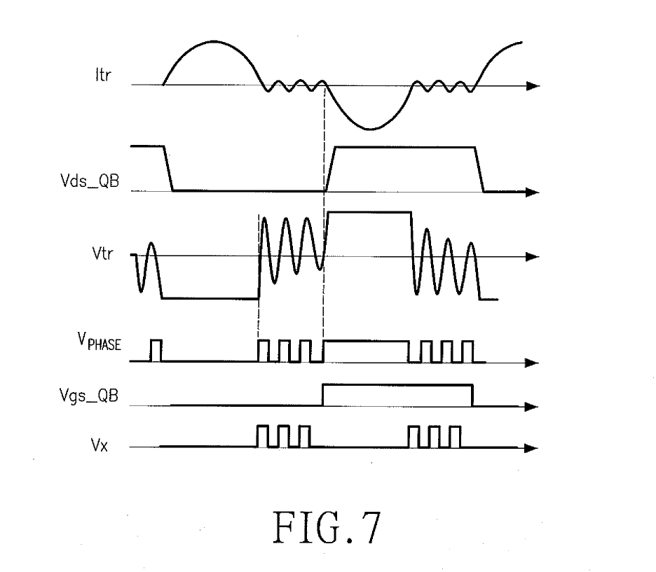

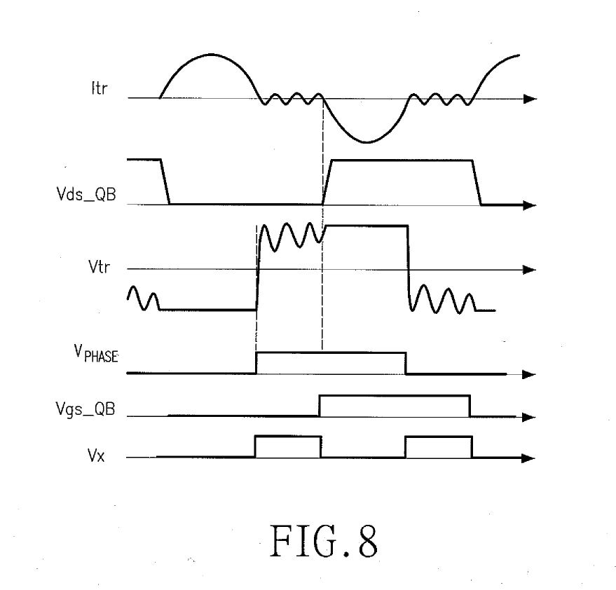

In the present embodiment, the logic gate 32 is an XOR (Exclusive OR) gate. The other input terminal of the logic gate 32 is connected to the resonant controller 25 to obtain a driving signal. The driving signal in the present embodiment is the gate-source voltage of the electronic switch QB (Vgs_QB). When operated under a light-load condition in FIG. 7 and a heavy-load condition in FIG. 8, the phase detector 30 transmits a voltage signal V_{PHASE} generated by comparing the transformer voltage Vtr with the DC reference signal to the logic gate 32 to perform an exclusive OR operation with the driving signal (Vgs_QB) and generate a pulse signal Vx. To ensure signal accuracy, the pulse signal is further filtered by the low-pass filter 33 to obtain a conversion voltage signal Vturn transmitted to the resonant controller 25 for the resonant controller 25 to determine if the resonant frequency Fr2 is inconsistent with the switching frequency Fs and perform compensation according to the determination result. Such compensation allows the resonant frequency Fr2 and the switching frequency Fs to approach to consistency. Depending on the operating state of the switching power supply, the definition of “approach to consistency” may be a condition that the switching frequency Fs approaches the resonant frequency Fr2 or that the switching frequency Fs is equal to the resonant frequency Fr2.

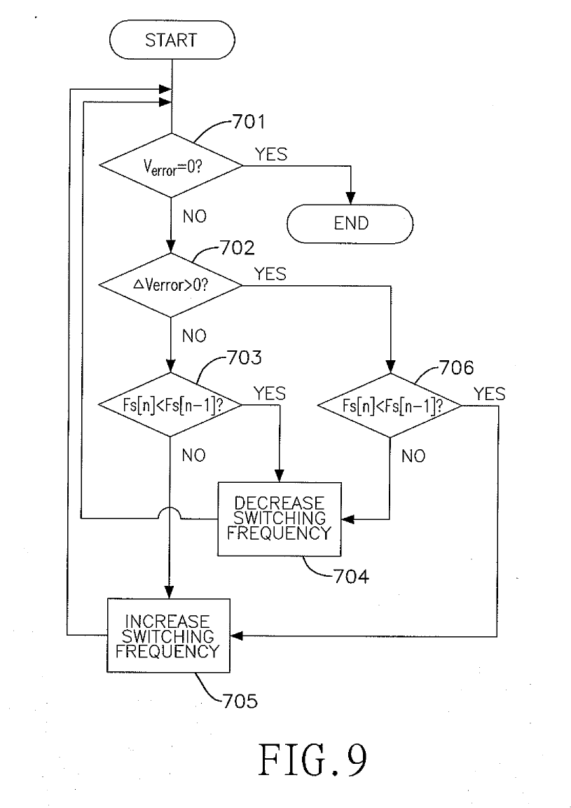

In the present embodiment, the resonant controller 25 has an operator 251 and a control unit 252. The operator 251 performs a subtraction operation between the conversion voltage Vturn and a reference voltage V_{REF} and sends an error value Verror out of the subtraction operation to the control unit 252 for the control unit 252 to determine if the compensation is necessary to be performed. The control unit 252 has a compensation process built therein. With reference to FIG. 9, the compensation process has the following steps.

Step 701: Determine if the error value Verror is equal to zero. If the error value Verror is zero, indicating a state that the resonant frequency Fr2 approaches or is equal to the switching frequency Fs, end the determination process. If the error value Verror is nonzero, indicating a state that the resonant frequency Fr2 and the switching frequency Fs are inconsistent, go to next step.

Step 702: Determine if a difference value (ΔVerror) between a present error value and a previous error value is greater than zero. If the difference value is not greater than the previous error value, go to next step (Step 703). Otherwise, perform step 706.

Step 703: Determine if a present switching frequency is less than a previous switching frequency. If the present switching frequency Fs(n) is less than the previous switching frequency Fs(n-1), perform Step 704 and return to Step 701. Otherwise, perform Step 705 and return to Step 701.

Step 704: Decrease the switching frequency Fs.

Step 705: Increase the switching frequency Fs.

Step 706: Determine if a present switching frequency is less than a previous switching frequency. If the present switching frequency Fs(n) is less than the previous switching frequency Fs(n-1), perform Step 705 and return to Step 701. Otherwise, perform Step 704 and return to Step 701.

After returning to Step 701, the compensation process continues operation until the error value Verror is equal to zero, indicating that the resonant frequency Fr2 and the switching frequency Fs are consistent.

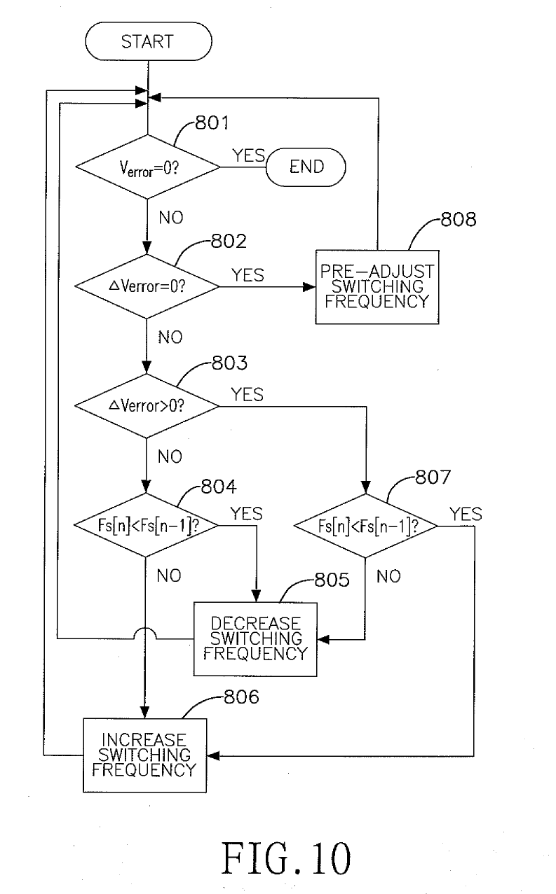

With reference to FIG. 10, the control unit 252 further has another compensation process built therein. The compensation process has the following steps.

Step 801: Determine if the error value Verror is equal to zero. If the error value Verror is zero, indicating a state that the resonant frequency Fr2 approaches or is equal to the switching frequency Fs, end the compensation process. If the error value Verror is nonzero, indicating a state that the resonant frequency Fr2 and the switching frequency Fs are inconsistent, go to next step.

Step 802: Determine if a difference value (ΔVerror) between a present error value and a previous error value is equal to zero. If the difference value is nonzero, go to next step (Step 803). Otherwise, perform step 808 and return to Step 801.

Step 803: Determine if the difference value is greater than zero. If the difference value is greater than zero, indicating that a previous pre-adjustment compensates the switching frequency in an opposite direction, perform Step 807. Otherwise, perform step 804.

Steps 804˜807 are substantially the same as Steps 703˜706 in the foregoing determination process except returning to Step 801 after decreasing or increasing the switching frequency Fs.

Step 804: Determine if a present switching frequency is not greater than a previous switching frequency. As the previous pre-adjustment compensates the switching frequency in a correct direction, if the present switching frequency Fs(n) is less than the previous switching frequency Fs(n-1), perform Step 805 and return to Step 801. Otherwise, perform Step 806 and return to Step 801.

Step 805: Decrease the switching frequency Fs.

Step 806: Increase the switching frequency Fs.

Step 807: Determine if a present switching frequency is less than a previous switching frequency. As the previous pre-adjustment compensates the switching frequency in an opposite direction, if the present switching frequency Fs(n) is less than the previous switching frequency Fs(n-1), perform Step 806 and return to Step 801. Otherwise, perform Step 805 and return to Step 801.

Step 808: Perform a pre-adjustment on the switching frequency Fs.

After returning to Step 801, the compensation process continues operation until the error value Verror is equal to zero, indicating that the resonant frequency Fr2 and the switching frequency Fs are consistent.

There are several ways of adjusting the switching frequency in the following. As the switching frequency Fs is related to a ratio of the output voltage and the input voltage (Vo/Vin) of the switching power supply or the gain, adjustment to any of the output voltage and the input voltage can change the switching frequency Fs. Furthermore, when the switching power supply is operated under an open-loop mode, fixed input voltage and variable output voltage are applied to adjust the switching frequency Fs. When the switching power supply is operated under a close-loop mode, variable input voltage is applied to adjust the switching frequency Fs.

According to the illustration of FIG. 1, an input voltage of the DC to DC converter 20 is supplied by the AC to DC converter 10, and when an output voltage of the AC to DC converter 10 varies, the switching frequency Fs of the DC to DC converter 20 is also changed. Hence, the resonant controller 25 of the DC to DC converter 20 generates a feedback voltage control signal (Bulk Control) and sends it to the control terminal BC of the AC to DC converter 10 to change the output voltage of the AC to DC converter 10. The input voltage of the DC to DC converter 20 is changed by varying the output voltage of the AC to DC converter 10, and the switching frequency Fs is thus adjusted. To one having ordinary skill in the art, it is understandable that both of the feedback DC voltage Vbulk and the feedback voltage control signal (Bulk Control) serve to adjust the output voltage of the AC to DC converter 10. A corresponding substantial implementation is described as follows.

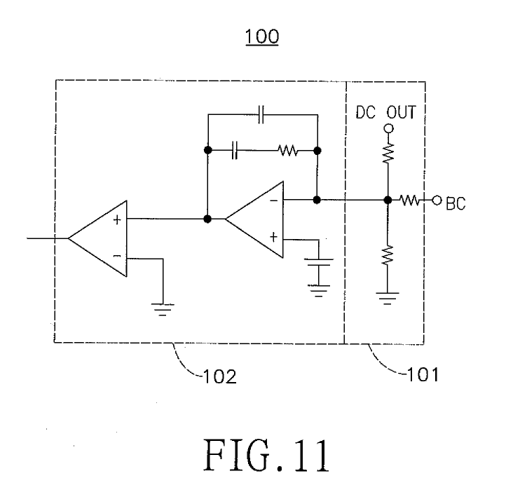

With further reference to FIG. 1, the AC to DC converter 10 has a control module 100. With reference to FIG. 11, the control module 100 has a superposition circuit 101 and a controller 102. The superposition circuit 101 has two input terminals and an output terminal. The two input terminals are respectively connected to the DC power output terminal DC OUT and the control terminal BC of the AC to DC converter 10 to acquire the feedback DC voltage Vbulk and the feedback voltage control signal (Bulk Control) for signal superposition. The superposing signal is sent to an input terminal of the controller 102 for the controller 102 to generate a driving signal for adjusting the DC voltage Vbulk on the DC power output terminal DC OUT of the AC to DC converter 10.

In sum, because of the production error of the resonant elements, the LLC circuit fails to accurately calculate the resonant frequency Fr2 beforehand. The uncertainty about the resonant frequency Fr2 results in difficulty in effective adjustment of a desired relationship between the switching frequency Fs and the resonant frequency Fr2. Instead of using a preset resonant frequency Fr2 as an adjustment basis, the present invention employs actually measured values to determine actual states of the switching frequency Fs and the resonant frequency Fr2. After the switching power supply enters a steady state, the switching frequency Fs is dynamically adjusted to increase operational efficiency and resolve the problem that the LLC circuit fails to accurately calculate the resonant frequency arising from the production error of the resonant elements.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A switching power supply, comprising:
an AC (Alternating Current) to DC (Direct Current) converter having an AC power input terminal, a DC power output terminal and a control terminal;
a DC to DC converter having:
a resonant converter;
a resonant controller; and
a phase detector connected to the resonant converter and the resonant controller to respectively acquire a transformer voltage and a driving signal and generating a conversion voltage signal based on the transformer voltage and the driving signal;
wherein the resonant controller generates a feedback voltage control signal according to the conversion voltage signal and sends the feedback voltage control signal to the control terminal of the AC to DC converter to adjust a DC voltage outputted from the AC to DC converter and further control a switching frequency of the resonant converter of the DC to DC converter.

2. The switching power supply as claimed in claim 1, wherein
the resonant converter has a transformer with at least one voltage-measuring point on the transformer; and
the phase detector has:
a comparator having:
an input terminal connected to one of the at least one voltage-measuring point on the transformer;
a reference terminal having a DC reference voltage level; and
an output terminal; and
a logic gate having:
a first input terminal connected to the output terminal of the comparator; and
a second input terminal connected to the resonant controller to acquire the driving signal.

3. The switching power supply as claimed in claim 2, wherein the phase detector further has a low-pass filter, and the second input terminal of the logic gate is connected to the resonant controller through the low-pass filter.

4. The switching power supply as claimed in claim 3, wherein the logic gate is an exclusive or (XOR) gate.

5. The switching power supply as claimed in claim 4, wherein the resonant controller has:
an operator performing a subtraction operation between the conversion voltage signal and a reference voltage; and
a control unit receiving a difference value generated by the subtraction operation of the operator and determining if the switching frequency of the DC to DC converter needs to be adjusted.

6. The switching power supply as claimed in claim 1, wherein
the resonant converter of the DC to DC converter is formed by an LLC circuit, wherein the LLC circuit has:
a full-bridge circuit having multiple paired electronic switches being alternately turned-on, wherein each electronic switch is connected to the resonant controller, and is turned on or off by the driving signal provided by the resonant controller;
a transformer having a primary side and a secondary side;
a resonant circuit connected between the DC power output terminal of the AC to DC converter and the primary side of the transformer, and having a resonant capacitor, an excited inductor, and a resonant inductor of the transformer; and
an output circuit connected to the secondary side of the transformer.

7. The switching power supply as claimed in claim 2, wherein
the resonant converter of the DC to DC converter is formed by an LLC (two inductors and one capacitor) circuit, wherein the LLC circuit has:
a full-bridge circuit having multiple paired and alternately turn-on electronic switches, wherein each electronic switch is connected to the resonant controller, and is turned on or off by the driving signal provided by the resonant controller;
a transformer having a primary side and a secondary side;
a resonant circuit connected between the DC power output terminal of the AC to DC converter and the primary side of the transformer, and having a resonant capacitor, an excited inductor, and a resonant inductor of the transformer; and
an output circuit connected to the secondary side of the transformer.

8. The switching power supply as claimed in claim 5, wherein
the resonant converter of the DC to DC converter is formed by an LLC (two inductors and one capacitor) circuit, wherein the LLC circuit has:
a full-bridge circuit having multiple paired and alternately turn-on electronic switches, wherein each electronic switch is connected to the resonant controller, and is turned on or off by the driving signal provided by the resonant controller;
a transformer having a primary side and a secondary side;
a resonant circuit connected between the DC power output terminal of the AC to DC converter and the primary side of the transformer, and having a resonant capacitor, an excited inductor, and a resonant inductor of the transformer; and
an output circuit connected to the secondary side of the transformer.

9. The switching power supply as claimed in claim 6, wherein
the AC to DC converter further has a control module, wherein the control module has:
a superposition circuit having:
two input terminals respectively connected to the DC power output terminal and the control terminal of the AC to DC converter; and
an output terminal; and
a controller having an input terminal connected to the output terminal of the superposition circuit.

10. The switching power supply as claimed in claim 7, wherein
the AC to DC converter further has a control module, wherein the control module has:
a superposition circuit having:
two input terminals respectively connected to the DC power output terminal and the control terminal of the AC to DC converter; and
an output terminal; and
a controller having an input terminal connected to the output terminal of the superposition circuit.

11. The switching power supply as claimed in claim 8, wherein
the AC to DC converter further has a control module, wherein the control module has:
a superposition circuit having:
two input terminals respectively connected to the DC power output terminal and the control terminal of the AC to DC converter; and
an output terminal; and
a controller having an input terminal connected to the output terminal of the superposition circuit.

12. The switching power supply as claimed in claim 9, wherein the at least one voltage-measuring point of the transformer is located at a coupling winding of the secondary side of the transformer, at a coupling winding of the primary side of the transformer, and at the secondary side of the transformer.

13. The switching power supply as claimed in claim 10, wherein the at least one voltage-measuring point of the transformer is located at a coupling winding of the secondary side of the transformer, at a coupling winding of the primary side of the transformer, and at the secondary side of the transformer.

14. The switching power supply as claimed in claim 11, wherein the at least one voltage-measuring point of the transformer is located at a coupling winding of the secondary side of the transformer, at a coupling winding of the primary side of the transformer, and at the secondary side of the transformer.

15. A method controlling a switching power supply having a resonant converter, comprising steps of:
acquiring a transformer voltage and a driving signal from the resonant converter to generate a present conversion voltage signal;
determining if the present conversion voltage signal is zero;
determining if a difference value between the present conversion voltage signal and a previous conversion voltage signal is greater than zero when the present conversion voltage signal is nonzero, wherein the previous conversion voltage signal is generated by a transformer voltage and a driving signal previously obtained; and
determining if a switching frequency of the resonant converter is reduced when the difference value is not greater than zero, decreasing the switching frequency when the switching frequency is reduced, and increasing the switching frequency when the switching frequency is not reduced.

16. The method as claimed in claim 15, further comprising a step of determining if the switching frequency of the resonant converter is reduced when the difference value is greater than zero, increasing the switching frequency when the switching frequency is reduced, and decreasing the switching frequency when the switching frequency is not reduced.

17. The method as claimed in claim 15, wherein in the step of determining if the difference value is nonzero,
when the conversion voltage signal is nonzero, first determining if the difference value between the present conversion voltage signal and a previous conversion voltage signal is zero;
when the difference value is nonzero, further determining if the difference value is greater than zero; and
when the difference value is zero, performing a pre-adjustment on the switching frequency and returning to the step of determining if the present conversion voltage signal is zero.

18. The method as claimed in claim 16, wherein in the step of determining if the difference value is nonzero,
when the conversion voltage signal is nonzero, first determining if the difference value between the present conversion voltage signal and a previous conversion voltage signal is zero;
when the difference value is nonzero, further determining if the difference value is greater than zero; and
when the difference value is zero, performing a pre-adjustment on the switching frequency and returning to the step of determining if the present conversion voltage signal is zero.

19. The method as claimed in claim 17, wherein an input voltage of the resonant converter is fixed and an output voltage of the resonant converter is controlled when operated under an open-loop mode to adjust the switching frequency; and
the input voltage of the resonant converter is adjustable and controlled when operated under a close-loop mode, so as to adjust the switching frequency.

20. The method as claimed in claim 18, wherein an input voltage of the resonant converter is fixed and an output voltage of the resonant converter is controlled when operated under an open-loop mode, and the input voltage of the resonant converter is controlled when operated under a close-loop mode, so as to adjust the switching frequency.
